(19) United States
(12) Patent Application Publication
(10) Pub. No.: US 2007/0151905 A1
(43) Pub. Date: Jul. 5, 2007

(54) Water purifier

(75) Inventors: Shun-Chung Wang, Taipei County (TW); Ren-Guey Lee, Taipei County (TW)

Correspondence Address: BIRCH STEWART KOLASCH & BIRCH, PO BOX 747, FALLS CHURCH, VA, 22040-0747, US

(73) Assignee: Metertek Technology Inc.

(21) Appl. No.: 11/319,457

(22) Filed: Dec. 29, 2005

(51) Int. Cl. B01D 25/30

(52) U.S. Cl. 210/97; 210/192; 422/186.3

(57) ABSTRACT

A water purifier is disclosed to include a water tank, an ultraviolet lamp mounted inside the water tank, a flow meter, which detects the flow rate of the fluid being supplied to the water tank and outputs a corresponding flow rate signal, and a lamp driver formed of a programmable monolithic chip that receives the flow rate signal from the flow meter and controls the light intensity of the ultraviolet lamp subject to the flow rate of the fluid being supplied to the water tank.

### BACKGROUND OF THE INVENTION

1. Field of the Invention

The present invention relates to water purifiers and more particularly, to a durable, inexpensive, power-saving, high-performance water purifier, which uses an ultraviolet lamp to sterilize the fluid in a water tank, a flow meter to detect the flow rate of the fluid being supplied to the water tank, and a programmable monolithic chip to control the light intensity of the ultraviolet lamp subject to the flow rate of the fluid being supplied to the water tank.

2. Description of the Related Art

Conventional water purifiers commonly use an ultraviolet lamp to sterilize the supplied water. These conventional water purifiers are functional, however they waste much electric energy because the ultraviolet lamp is constantly maintained in the full-load status.

There is known another prior design water purifier, which comprises a flow witch, and uses an electronic lamp driver to control the operation of the ultraviolet lamp. The electronic lamp driver comprises a boost transformer and an oscillator. The boost transformer has a primary side and a secondary side. The oscillator controls power supply to the primary side of the boost transformer. This water purifier further comprises an oscillator control method adapted to control the frequency of the oscillator subject to the status of the flow switch. When the water stands still, the oscillator is driven to oscillate at a first frequency. When the water is flowing, the oscillator is driven to oscillate at a second frequency. This design of water purifier automatically turns on/off the ultraviolet lamp subject to the flowing status of the water. However, when the water is flowing, the ultraviolet lamp is maintained in the full-load status, i.e., the light intensity of the ultraviolet lamp is not linearly controlled subject to the flow rate of the supplied water. Therefore, this design of water purifier still wastes much electric energy.

### SUMMARY OF THE INVENTION

The present invention has been accomplished under the circumstances in view. It is one object of the present invention to provide a water purifier, which automatically controls the light intensity of the ultraviolet lamp subject to the flow rate of the supplied water, thereby saving power consumption. It is another object of the present invention to provide a water purifier, which automatically correct the light intensity of the ultraviolet lamp, and gives an indication signal when the ultraviolet lamp failed or has been aged.

To achieve these and other objects of the present invention, the water purifier comprises a water tank, the water tank having a water inlet at one end thereof and a water outlet at an opposite end thereof; an ultraviolet lamp mounted inside the water tank; a flow meter connected to the water inlet of the water tank and adapted to detect the flow rate of a fluid passing through the water inlet into said water tank and to provide a flow rate signal; and a lamp driver electrically coupled between the low meter and the ultraviolet lamp, the lamp driver comprising a programmable monolithic chip adapted to receive the flow rate signal and to output a linear control signal to the ultraviolet lamp to control the light intensity of the ultraviolet lamp subject to the value of the flow rate signal.

### BRIEF DESCRIPTION OF THE DRAWINGS

FIG. 1 is a schematic drawing showing the control architecture of a water purifier according to the present invention.

FIG. 2 is a circuit block diagram of the water purifier according to the present invention.

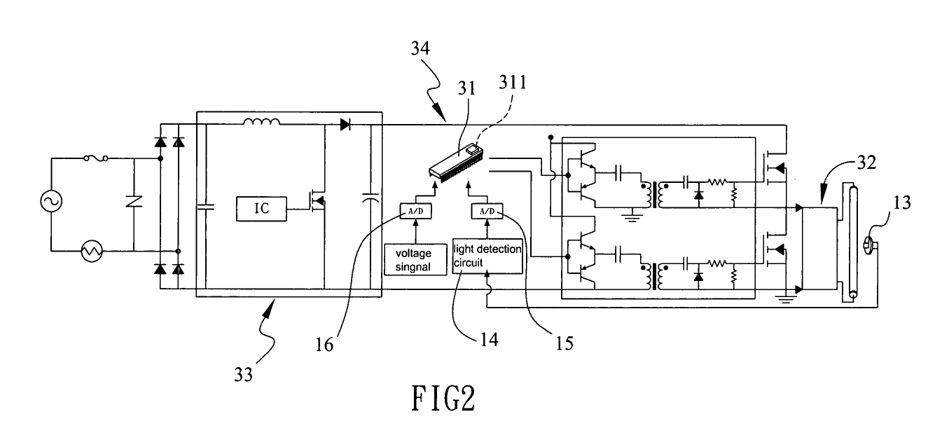

FIG. 3 is an elevational view showing the outer appearance of the flow meter for the water purifier according to the present invention.

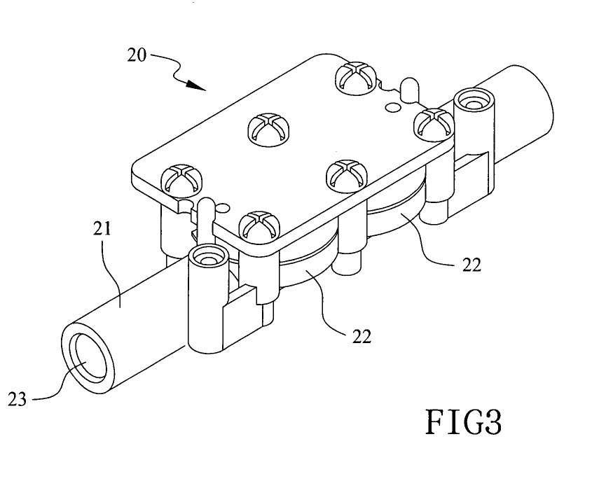

FIG. 4 is a schematic sectional view of the flow meter for the water purifier according to the present invention.

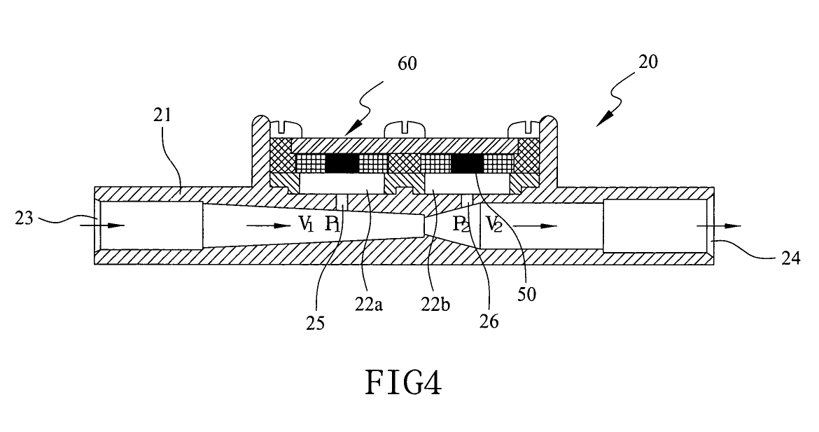

### DETAILED DESCRIPTION OF THE PREFERRED EMBODIMENT

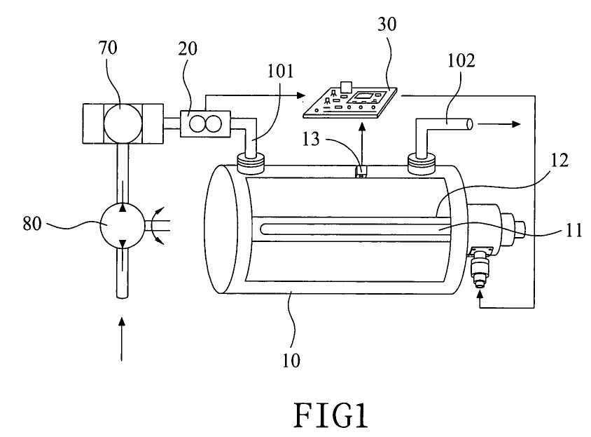

Referring to FIGS. 1˜4, a water purifier in accordance with the present invention is shown comprising a water tank 10, a flow meter 20, and a lamp driver 30.

The water tank 10 has a water inlet 101 at one end, a water outlet 102 at the other end, a quartz tube 12 suspending on the inside, and an ultraviolet lamp 11 mounted inside the quarts tube 12.

The flow meter 20 is connected to the water inlet 101 for measuring the amount of flow of water passing through the water inlet 101 into the inside of the water tank 10. The flow meter 20 according to the present preferred embodiment comprises a water pipe 21, a cover plate 60, and two pressure sensors 50 installed in the bottom side of the cover plate 60. The water pipe 21 is formed of a venturi tube, having a gradually reducing water inlet pipe section 23 and a gradually increasing water outlet pipe section 24 axially connected in a line, and a holder block 22 fixedly provided at the periphery corresponding to the connection area between the gradually reducing water inlet pipe section 23 and the gradually increasing water outlet pipe section 24. The holder block 22 has two upwardly extending open chambers 22a and 22b, and two vertical through holes 25 and 26 respectively disposed in communication between the upwardly extending open chambers 22a and 22b and the gradually reducing water inlet pipe section 23 and the gradually increasing water outlet pipe section 24. The cover plate 60 is covered on the holder block 22 to close the upwardly extending open chambers 22a and 22b, holding the pressure sensors 50 in the upwardly extending open chambers 22a and 22b corresponding to the through holes 25 and 26 respectively. The pressure sensors 50b are sealed with silicon rubber. The flow meter 20 converts measured flow rate signal into a linear electric voltage signal, which is then converted into digital signal by an A/D (analog-to-digital) converter 16 and then transmitted to a programmable monolithic chip 31, enabling the programmable monolithic chip 31 to control the output power of the ultraviolet lamp 11 subject to the flow rate passing through the flow meter 20.

The lamp driver 30 is electrically connected to the flow meter 20, comprising the aforesaid programmable monolithic chip 31 adapted to receive flow rate signal from the flow meter 20. The programmable monolithic chip 31 comprises a pulse-width modulator 311, which controls the intensity of light of the ultraviolet lamp 11 subject to the flow rate passing through the flow meter (i.e., the pressure difference detected by the pressure sensors 50). The lamp driver 30 further comprises a resonant driving circuit 32, a power rectifier circuit 33, and a single-chip control circuit 34 for ultraviolet lamp driving control.

Further, a photo sensor 13 (for example, photoresistance) is installed in the water tank 10 and adapted to transmit the detected light source signal to the programmable monolithic chip 31 through a light detection circuit 14 and an A/D (analog-to-digital) converter 15, enabling the programmable monolithic chip 31 to automatically calibrate the light intensity of the ultraviolet lamp 11 subject to the detection results of the photo sensor 13.

Referring to FIG. 1 again, the aforesaid water tank 10, flow meter 20 and a lamp driver 30 form the water purifier of the present invention. When starting, the invention proceeds with a transient starting procedure to start the ultraviolet lamp 11, preventing burning of the ultraviolet lamp 11 due to a high starting current. The invention also provides a matched switching frequency to change the power of the ultraviolet lamp 11 subject to the flow rate passing through the flow meter 20 into the water tank 10. When the voltage signal is 0V, the switching frequency outputted by the driving circuit maintains the half load operating power of the ultraviolet lamp 11. When the voltage signal is greater than 0V, the switching frequency outputted by the driving circuit to the ultraviolet lamp 11 is directly proportionally increased from the half load operating power to a specific voltage value, reaching the maximum operating power of the ultraviolet lamp 11. The lamp driver 30 is electrically coupled to the flow meter 20, and the programmable monolithic chip 31 of the lamp driver 30 receives the flow rate signal from the flow meter 20, enabling the pulse-width modulator 311 to control the light intensity of the ultraviolet lamp subject to the flow rate of the water passing through the flow meter 20 (i.e., subject to the pressure difference detected by the pressure sensors 50). Further, by means of the light detection circuit 14 and the A/D (analog-to-digital) converter 15, the photo sensor 13 transmits the detected light source signal to the programmable monolithic chip 31, enabling the programmable monolithic chip 31 to automatically calibrate the light intensity of the ultraviolet lamp 11. When the photo sensor 13 detects no signal, it means that the working loop of the ultraviolet lamp 11 has failed. At this time, the ultraviolet lamp failure indication means or circuit burning indication means is started to give an indication. If the light intensity of the ultraviolet lamp 11 does not reach the rated tolerance range, it means that the ultraviolet lamp 11 has been aged and must be replaced.

Further, the resonant driving circuit 32 of the lamp driver 33 defines the equivalent resistance value of the ultraviolet lamp 11 linearly, adopting different resonance meshes to make light regulation analysis. The resonance meshes can be based on the architecture of series resonance and parallel load. The power rectifier circuit 33 is based on a boost architecture to match with a control IC. The operation flow of the single-chip control circuit 34 is outlined hereinafter. When started, the controller changes the frequency to start the ultraviolet lamp 11, preventing transient surge current at the ends of the ultraviolet lamp 11 and protecting the service life of the ultraviolet lamp 11. After started, the operating power (P_{duv}) of the ultraviolet lamp 11 is determined subject to the flow rate signal from the flow meter 20, and the actual power (Pₒᵤᵥ) of the ultraviolet lamp 11 under the current light intensity is detected. The flow rate and the light intensity are calculated proportionally for the success value, and then it judges if the actual power (Pₒᵤᵥ) of the ultraviolet lamp 11 is zero (no light source) or not. If the actual power (Pₒᵤᵥ) of the ultraviolet lamp 11 is zero, it means that the ultraviolet lamp 11 is not successfully started or has failed, at this time start the warning circuit and close the turn off half bridge output. If the actual power (Pₒᵤᵥ) of the ultraviolet lamp 11 is greater than zero (there is a light source), it compares the actual power (Pₒᵤᵥ) to the operating power (P_{duv}) and then increase or reduce the operating frequency of the half bridge circuit subject to the positive/negative value of the comparison result. If light attenuation occurs, the same feedback control procedure is employed to make up the attenuation, making the actual power (Pₒᵤᵥ) to be equal the operating power (P_{duv}).

Referring to FIG. 1 again, a water filter 70 and a water supply pump 80 may be used and connected to the front side of the flow meter 20. The water supply pump 80 pumps water into the water filter 70 and then the flow meter 20. The water filter 70 filtrates the water being supplied to the flow meter 20.

According to the aforesaid design, the power-saving mode of the present invention saves the consumption of power of the ultraviolet lamp when water supply is stopped, and automatically regulates the output power of the ultraviolet lamp subject to the flow rate of the water being supplied to the water tank. Therefore the invention saves much the energy and the expense for electricity, and has the advantages of high power, low cost, high performance, high convenience and safeness, and high industrial value.

A prototype of a water purifier has been constructed with the features of FIGS. 1˜4. The water purifier functions smoothly to provide all of the features disclosed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A water purifier comprising:
a water tank, said water tank having a water inlet at one end thereof and a water outlet at an opposite end thereof;
an ultraviolet lamp mounted inside said water tank;
a flow meter connected to the water inlet of said water tank and adapted to detect the flow rate of a fluid passing through said water inlet into said water tank and to provide a flow rate signal; and
a lamp driver electrically coupled between said flow meter and said ultraviolet lamp, said lamp driver comprising a programmable monolithic chip adapted to receive said flow rate signal and to output a linear control signal to said ultraviolet lamp to control the light intensity of said ultraviolet lamp subject to the value of said flow rate signal.

2. The water purifier as claimed in claim 1, wherein said flow meter comprises a water pipe formed of a venturi tube, said water pipe having a gradually reducing water inlet pipe section and a gradually increasing water outlet pipe section axially connected in a line, and a holder block fixedly provided at the periphery thereof corresponding to the connection area between said gradually reducing water inlet pipe section and said gradually increasing water outlet pipe section, said holder block having two upwardly extending open chambers, and two vertical through holes respectively disposed in communication between said upwardly extending open chambers and said gradually reducing water inlet pipe section and gradually increasing water outlet pipe section; a cover plate covered on said holder block to close said upwardly extending open chambers; and two pressure sensors respectively installed in said cover plate inside said upwardly extending open chambers corresponding to said two vertical through holes and sealed with silicon rubber.

3. The water purifier as claimed in claim 2, wherein said water tank comprises a quartz tube suspending on the inside and adapted to accommodate said ultraviolet lamp.

4. The water purifier as claimed in claim 2, wherein said programmable monolithic chip comprises a pulse width modulator adapted to output a linear control signal to said ultraviolet lamp to control the light intensity of said ultraviolet lamp subject to the flow rate of the fluid passing through said flow meter.

5. The water purifier as claimed in claim 2, wherein said programmable monolithic chip comprises a pulse width modulator adapted to output a linear control signal to said ultraviolet lamp to control the light intensity of said ultraviolet lamp subject to the pressure difference detected by said pressure sensors.

6. The water purifier as claimed in claim 2, further comprising a photo sensor installed in said water tank, said photo sensor comprising a light detection circuit and an analog-to-digital converter and being adapted to detect the light intensity of said ultraviolet lamp and to output a corresponding light source signal to said programmable monolithic chip for enabling said programmable monolithic chip to calibrate the light intensity of said ultraviolet lamp.

7. The water purifier as claimed in claim 2, wherein said flow meter further comprises means to convert said flow rate signal into a linear voltage signal and an analog-to-digital converter adapted to convert said linear voltage signal into a digital signal for output to said programmable monolithic chip for controlling the operating power of said ultraviolet lamp.

8. The water purifier as claimed in claim 2, wherein said lamp driver is comprised of a resonant driving circuit, a power rectifier circuit and a single-chip control circuit.
